(19) United States
(12) Patent Application Publication
(10) Pub. No.: US 2021/0116024 A1
(43) Pub. Date: Apr. 22, 2021

(54) VARIABLE APPLY DIAMETER PISTON

(71) Applicant: GM GLOBAL TECHNOLOGY OPERATIONS LLC, DETROIT, MI (US)

(72) Inventor: Joaquin J. Affonso, III, Macomb, MI (US)

(21) Appl. No.: 16/655,464

(22) Filed: Oct. 17, 2019

(51) Int. Cl. F16H 63/30; F16D 48/02; F16D 25/06; F16J 1/00

(52) U.S. Cl. CPC F16H 63/3023; F16D 25/14; F16H 2063/3089; F16J 1/001; F16D 25/06

(57) ABSTRACT

A torque transmitting device and a mechanism for applying a force to engage the torque transmitting device include a piston having an inner apply face and an outer apply face, where the inner apply face is offset from the outer apply face along an apply axis of the piston. A spring is disposed adjacent to the inner apply face or the outer apply face. The spring is configured to contact an adjacent plate of the torque transmitting device. The mechanism is movable between a first engaged position, a second engaged position, and a disengaged position. The mechanism is configured to apply force to the adjacent plate through the spring and one of the inner and outer apply faces in the first engaged position, and the mechanism is configured to apply force to the adjacent plate through the spring and through both apply faces in the second engaged position.

### FIELD

The invention relates generally to an actuator mechanism, and more particular, to an actuator mechanism for actuating a torque transmitting device, for example, in an automotive transmission.

### INTRODUCTION

A typical multi-speed automatic or hybrid transmission uses a combination of torque transmitting devices, such as clutches or brakes, to achieve a plurality of forward and reverse gear or speed ratios as well as a Neutral and a Park. Selection of speed ratios is typically accomplished by a microprocessor transmission control module that employs various vehicle parameters, for example vehicle speed, and various driver input signals, for example accelerator pedal position, to select the appropriate speed ratios. The transmission then engages a combination of the toque transmitting devices to provide the desired gear or speed ratios.

In order to engage the torque transmitting devices, a typical automatic or hybrid transmission includes a hydraulic clutch control system that employs a hydraulic fluid to selectively actuate pistons within the torque transmitting devices and to provide lubrication to the device. Actuation of a piston in turn engages the torque transmitting elements (i.e., friction discs and metal plates) within the torque transmitting device.

A clutch pack of a torque transmitting device is often sized to hold a maximum amount of static torque, which typically requires the apply diameter to be large and results in an abrupt shift feel that may be felt by the driver or passengers of the vehicle. A smaller apply diameter would create a more desirable shift feel, but may not hold up under all loads.

### SUMMARY

The present disclosure provides a piston having two different apply diameters based on the apply pressure exerted by the piston. Accordingly, at lower apply pressures where maximum torque is not required, a smaller apply diameter may be used to engage the torque transmitting device. A larger apply diameter is used to engage the torque transmitting device when a large amount of torque carrying capacity is required and a higher apply pressure is used to engage the piston.

In one form, which may be separate from or combined with the other forms disclosed herein, a mechanism for applying a force to engage a torque transmitting device is provided. The mechanism includes a piston and a spring. The piston has an inner apply face and an outer apply face. The inner apply face is offset from the outer apply face along an apply axis of the piston. The spring is disposed adjacent to the inner apply face or the outer apply face, and the spring is configured to contact an adjacent plate of the torque transmitting device. The mechanism is movable between a first engaged position, a second engaged position, and a disengaged position. The mechanism is configured to apply force to the adjacent plate through the spring and through one of the inner and the outer apply faces in the first engaged position, and the mechanism is configured to apply force to the adjacent plate through the spring and through both of the inner and the outer apply faces in the second engaged position.

In another form, which may be combined with or separate from the other forms disclosed herein, a torque transmitting device is provided that includes a plurality of interleaved clutch plates configured to selectively couple a first member to a second member. An actuator mechanism is disposed on one side of the plurality of interleaved clutch plates. The actuator mechanism is configured to compress the plurality of clutch plates together to couple the first and second members. The actuator mechanism includes a spring and a piston having an inner apply face and an outer apply face. The inner apply face is offset from the outer apply face along an apply axis of the piston. The spring is disposed adjacent to the inner apply face or the outer apply face, and the spring is configured to contact an adjacent plate of the plurality of interleaved clutch plates. The actuator mechanism is movable between a first engaged position, a second engaged position, and a disengaged position. The actuator mechanism is configured to apply force to the adjacent plate through the spring and through one of the inner and the outer apply faces in the first engaged position, and the actuator mechanism is configured to apply force to the adjacent plate through the spring and through both of the inner and the outer apply faces in the second engaged position.

In yet another form, which may be combined with or separate from the other forms disclosed herein, a mechanism for applying a force to engage a torque transmitting device is provided. The mechanism includes an annular piston having an annular outer surface and an annular inner surface. The piston has an inner apply face and an outer apply face, the outer apply face being disposed radially outward of the inner apply face. The inner apply face is axially offset from and disposed axially proximal of the outer apply face along an apply axis of the piston. A spring is disposed adjacent to the inner apply face and radially inward of the annular outer surface of the piston to define a gap between the spring and the annular outer surface of the piston. The spring is configured to contact an adjacent plate of the torque transmitting device. The mechanism is movable between a first engaged position, a second engaged position, and a disengaged position. The mechanism is configured to apply force to the adjacent plate through the spring and the inner apply face in the first engaged position, and the mechanism is configured to apply force to the apply plate through the spring and through the inner and the outer apply faces in the second engaged position.

Additional features may optionally be provided, including but not limited to the following: the inner and outer apply faces being free from direct contact with the adjacent plate in the first engaged position; one of the inner and outer apply faces being configured to directly contact the adjacent plate in the second engaged position; the mechanism being configured to apply a first engagement force to the adjacent plate through the spring and through one of the inner and the outer apply faces in the first engaged position; the mechanism being configured to apply a second engagement force to the adjacent plate through the spring and through both of the inner apply face and the outer apply face in the second engaged position; the second engagement force being greater than the first engagement force; the mechanism being configured to apply a first engagement force to the adjacent plate through the spring and through one of the inner apply face and the outer apply face in the first engaged position through a first apply area; the mechanism being configured to apply a second engagement force to the adjacent plate through the spring and through both of the inner apply face and the outer apply face in the second engaged position through a second apply area; the second apply area being greater than the first apply area; the spring being disposed adjacent to the inner apply face; the outer apply face being configured to contact the adjacent plate in the second engaged position; the spring being a wave spring having multiple turns; the spring having a K factor in the range of 1.3 to 4.0 million Newtons per meter; the spring defining an inner apply diameter along a mean diameter of the spring; the inner apply face and the outer apply face together defining an outer apply diameter defined centrally between the annular inner surface and the annular outer surface of the piston; the mechanism being configured to apply force to the adjacent plate along the inner apply diameter in the first engaged position; and the mechanism being configured to apply force to the adjacent plate along the outer apply diameter in the second engaged position.

Further features, aspects, and advantages of the present disclosure will become apparent by reference to the following description and appended drawings, wherein like reference numbers refer to the same component, element, or feature.

### DRAWINGS

The drawings described herein are for illustration purposes only and are not intended to limit the scope of the present disclosure in any way.

FIG. 1 is a cross-sectional view of a portion of an automatic transmission having a torque transmitting device including an actuator mechanism having a piston and a spring in a disengaged position, in accordance with the principles of the present disclosure;

FIG. 2A is a perspective view of the piston of the actuator mechanism of FIG. 1, according to the principles of the present disclosure;

FIG. 2B is a perspective of the spring of the actuator mechanism of FIG. 1, in accordance with the principles of the present disclosure;

FIG. 3 is a cross-sectional view of the portion of the automatic transmission having the torque transmitting device including the actuator mechanism of FIG. 1, with the actuator mechanism in a first engaged position, in accordance with the principles of the present disclosure; and

FIG. 4 is a cross-sectional view of the portion of the automatic transmission having the torque transmitting device including the actuator mechanism of FIGS. 1 and 3, with the actuator mechanism in a second engaged position, in accordance with the principles of the present disclosure.

### DETAILED DESCRIPTION

The following description is merely exemplary in nature and is not intended to limit the present disclosure, its application, or uses.

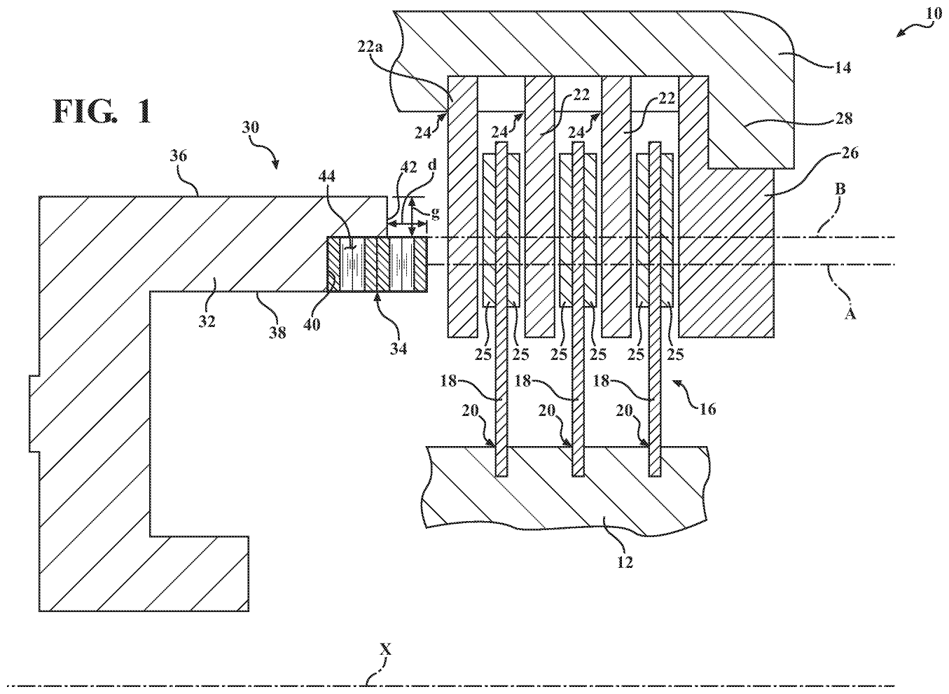

With reference to FIG. 1, an illustration of a portion of an automotive transmission is illustrated and generally designated at 10. The transmission 10 may include a plurality of planetary gear assemblies, which are generally not shown, but one or more gears of which may be coupled to a hub 12 and/or a housing 14. The housing 14 may be a clutch housing or a transmission case, by way of example. Either transmission component 12, 14 may be rotating or stationary. Operably disposed between the hub 12 and the housing 14 is a torque transmitting device 16, which is a friction clutch assembly, in this example. The torque transmitting device 16 is configured to selectively couple the hub 12 (and any planetary gear elements, shafts, or stationary elements coupled to the hub 12) to the housing 14 (and any planetary gear elements, shafts, or stationary elements coupled to the housing 14). Although the torque transmitting device 16 is illustrated as part of an automotive transmission 10, it should be understood that the torque transmitting device 16 could be used in other applications, without falling beyond the spirit and scope of the present disclosure. The components illustrated in FIG. 1 should be understood to be generally annular and extend rotationally about a central axis X of the transmission 10.

The torque transmitting device 16 includes a first plurality of smaller diameter clutch plates or discs 18 which are coupled by interengaging male and female splines 20 to the hub 12, which is an inner torque carrying member. A second plurality of larger diameter plates or discs 22 are coupled by interengaging male and female splines 24 to the clutch housing 14, which is an outer generally annular torque carrying member. The second clutch plates 22 are interleaved with the first clutch plates 18. In accordance with conventional friction clutch practice, at least one face of the friction clutch plates or discs 18, 22 includes friction material 25 disposed thereon. In this example the smaller-diameter clutch plates 18 may be referred to as friction clutch plates, while the larger diameter plates 22 may be referred to as reaction plates, but it should be understood that the placement of the type of plates 18, 22 could be reversed, or friction material could additionally be included on the reaction plates 22.

At one end of the torque transmitting device 16 (the right end in the configuration of FIG. 1) is disposed an annular backing plate 26. The backing plate 26 is located and restrained against axial motion by a lip 28 of the housing 14, in this example, however, it should be understood that other restraint devices could be used, such as a snap ring (not shown), or other similar components.

At the other end of the torque transmitting device 16 (the left end in the orientation of FIG. 1) is disposed a hydraulic, electric, or pneumatic operator or actuator mechanism 30, which selectively provides an axial compressive force to the interleaved clutch plates 18, 22 to cause torque transfer therethrough and to move the torque transmitting device 16 into an engaged position to couple together the first and second members 12, 14. The actuator mechanism 30 may apply a force to an adjacent apply plate or pressure plate 22a to compress the first and second clutch plates 18, 22 together.

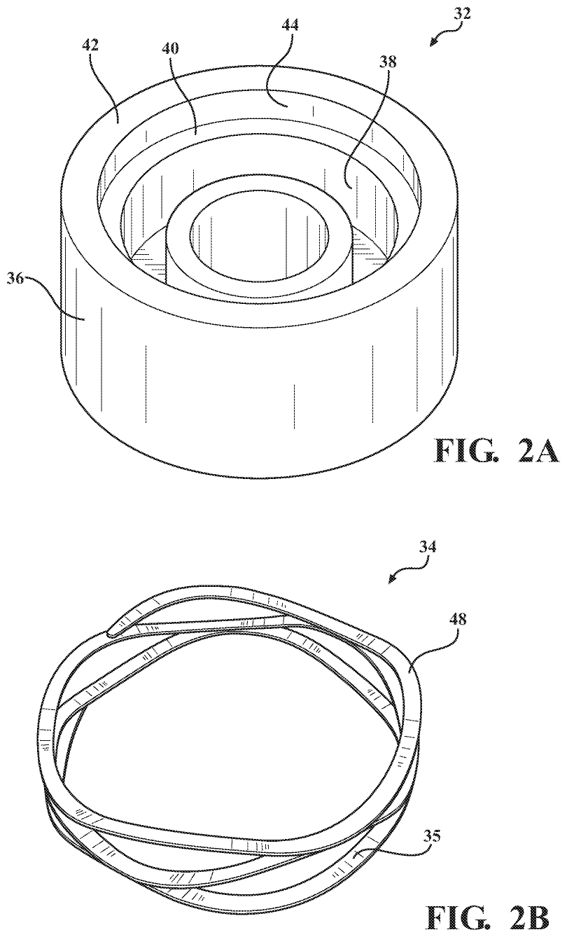

Referring to FIGS. 1, 2A, and 2B, the actuator mechanism 30 includes a piston 32 and a spring 34. The piston 32 is generally annular and defines an outer annular surface 36 and an inner annular surface 38. The piston 32 has an inner apply face 40 and an outer apply face 42. In this example, both the inner and outer apply faces 40, 42 are flat and each is disposed in its own plane that is perpendicular to the longitudinal central axis X of the transmission 10. The outer apply face 42 is disposed radially outward of the inner apply face 40. The inner apply face 40 is axially offset from the outer apply face 42 along an apply axis of the piston 32. The apply axis may be understood to mean an axis extending along the direction that the piston 32 is applied, such as the central axis X. In this example, the inner apply face 40 is further from the adjacent apply plate 22a than the outer apply face is from the adjacent apply plate 22a. Thus, each of the inner and outer apply faces 40, 42 are offset from one another in an axial direction along the apply axes A, B (which form apply diameters about the central X). Accordingly, the inner apply face 40 may be described as being axially proximal to the outer apply face 42.

The spring 34 is disposed adjacent to the inner apply face 40, between the inner apply face 40 and the adjacent apply plate 22a. The piston forms an inner pocket 44 in which the spring 34 is disposed. In this example, the spring 34 is disposed adjacent to the inner apply face 40 and radially inward of the annular outer surface 36 of the piston 32 to define a gap g between the spring 34 and the annular outer surface 36 of the piston 32.

Although the illustrated configuration shows the spring being disposed in alignment with the annular inner surface 38 of the piston 32, it should be understood that, in the alternative, the outer face 42 could form the pocket in which the spring 34 is disposed, and the spring could be aligned with the annular outer surface 36 of the piston 36 in other embodiments. Furthermore, though shown as being radially aligned or flush with the inner annular surface 38 of the piston 32, the spring 34 could alternatively extend radially inward of the inner annular surface 38. Likewise, in a configuration where the spring 34 is disposed along the outer annular surface 36 of the piston, the spring 34 could extend radially outward of the outer annular surface 36, if desired.

In this example, the spring 34 is a loose multiple turn, or multi-turn, wave spring having a high K factor (or a high amount of stiffness), because the spring 34 forms part of the engagement mechanism, which will be described in further detail below. Thus, in some examples, the K factor of the spring 34 may be in the range of 1.3 to 4.0 million Newtons per meter. The spring 34 is configured to contact the adjacent apply plate 22a of the torque transmitting device 16 and the inner apply face 40, at least when compressed. The multi-turn wave spring 34 may be formed of a single continuous piece of metal 35, such as steel, that is waved and then looped around on top of itself.

The actuator mechanism 30 is movable between a first engaged position, a second engaged position, and a disengaged position. In FIG. 1, the disengaged position is illustrated, with the spring 34 not compressed against the apply plate 22a. In the disengaged position, the spring 34 extends axially beyond the outer apply face 42 by a distance d. When the actuator mechanism 30 is engaged, for example, through hydraulic, pneumatic, or electric means, the piston 32 moves to the right in the orientation shown in FIG. 1.

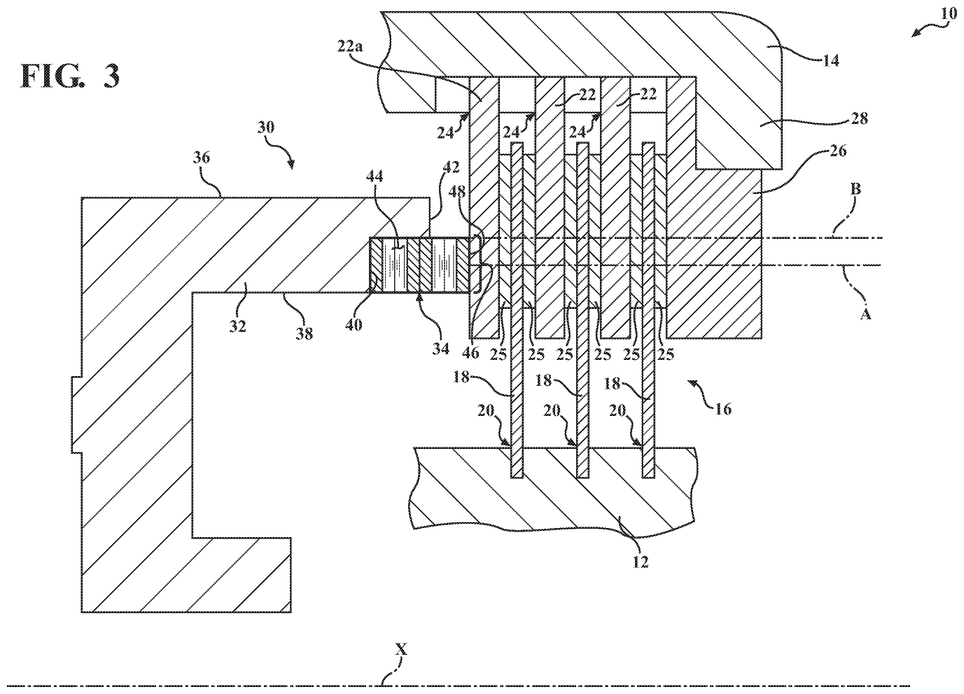

Referring now to FIG. 3, a first engaged position of the actuator mechanism 30 is illustrated. When engaged and a first amount of pressure is applied through the actuator mechanism 30, the inner apply face 40 of the piston 32 presses against the spring 34 and brings the spring 34 into contact with the apply plate 22a. The spring 34, which has a high amount of stiffness begins to compress the clutch plates 18, 22 together and couples the first member 12 to the second member 14. In some examples, the spring 34 may be effective to partially compress the plates 18, 22 in a slipping condition, or the spring 34 may be effective to engage the plates 18, 22 with enough force to couple the members 12, 14 together.

The actuator mechanism 30 is configured to apply force to the adjacent plate 22a through the spring 34 and through the inner apply face 40 behind the spring 34 in the first engaged position. Both the inner and outer apply faces 40, 42 of the piston 32 are free from direct contact with the adjacent plate 22a in the first engaged position, and only the spring 34 of the actuator mechanism 30 is in direct contact with the apply plate 22a to engage the torque transmitting device 16. The engagement of the torque transmitting device 16 through the spring 34 allows some compliance to the force, which provides for a softer shift feel than would be the case between two rigid surfaces.

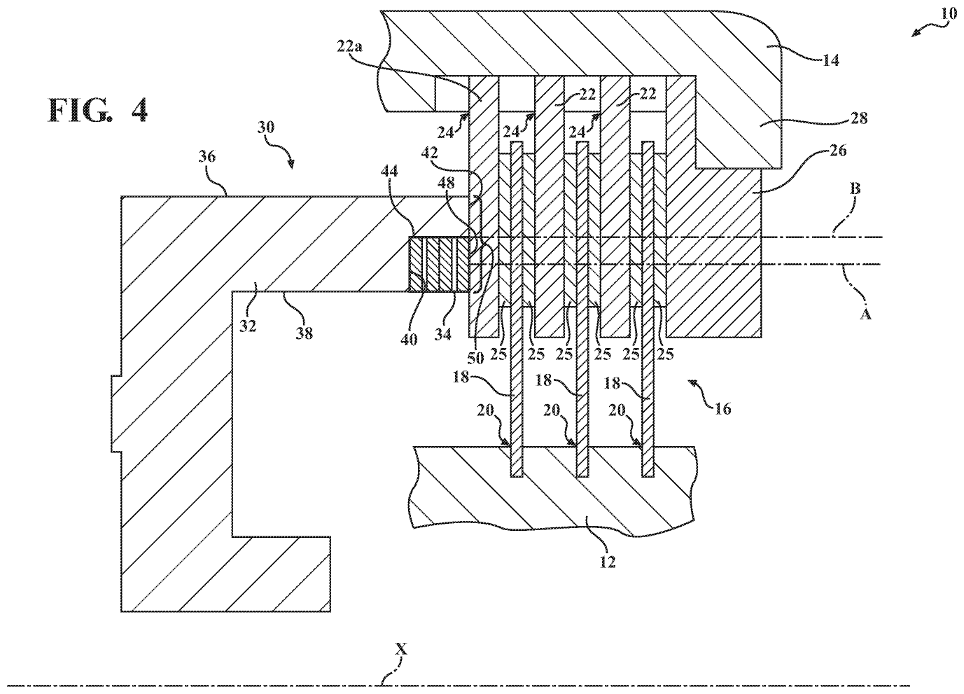

Referring now to FIG. 4, and with continued reference to FIGS. 1 and 3, a second engaged position of the actuator mechanism 30 is illustrated. Accordingly, after reaching the first engaged position shown in FIG. 3, a greater amount of pressure may be applied through the actuator mechanism 30 to push the piston 32 further (to the right, in the orientation of FIG. 1) and to compress the spring 34 and bring the outer apply face into contact with the apply plate 22a. Thus, when the actuator mechanism is in the second engaged position, or fully engaged position, the spring 34 is compressed within the pocket 44 between the inner apply face 40 and the apply plate 22a, and the outer apply face 42 directly contacts the apply plate 22a. The members 12, 14 are coupled together through the greater force required to push the outer apply face 42 against the apply plate 22a, which may carry a high torque load. Therefore, when a higher static torque carrying capacity is required, the actuator mechanism 30 is used in the second engagement position to engage the torque transmitting device 16.

Thus, the actuator mechanism 30 applies a first engagement force to the adjacent plate 22a through the spring 34 and through the inner apply face 40 in the first engaged position (shown in FIG. 3), and the actuator mechanism applies a second engagement force to the adjacent plate 22a through the spring 34 and through the both the inner apply face 40 and the outer apply face 42 in the second engaged position (shown in FIG. 4). The second engagement force is greater than the first engagement force, such that greater force is required to further compress the spring 34 into the pocket 44 as shown in FIG. 4 and abut the outer apply face 42 of the piston 32 against the apply plate 22a.

The spring 34 defines an inner apply diameter A along a mean diameter of the annular spring 34. The apply diameter A forms an apply diameter ring surrounding the central axis X, and the apply diameter A contains an infinite number of lines that are parallel to the central axis X of the transmission 10 and disposed annularly about the central axis X, one of which is illustrated in FIGS. 1, 3, and 4. In the first engaged position (shown in FIG. 3), the actuating force is applied along the inner apply diameter A through the spring 34 and through the inner apply face 40 behind the spring 34.

The inner apply face 40 and the outer apply face 42 together define an outer apply diameter B defined centrally between the annular inner surface 38 (or an inner diameter of the spring 34) and the annular outer surface 36 of the piston 32. Like the inner apply diameter A, the apply diameter B forms an apply diameter ring surrounding the central axis X, and the apply diameter B contains an infinite number of lines that are parallel to the central axis X of the transmission 10 and disposed annularly about the central axis X, one of which is illustrated in FIGS. 1, 3, and 4. The apply diameter ring B is larger than the apply diameter ring A. In the second engaged position (shown in FIG. 4), the actuator mechanism 30 applies force to the adjacent plate 22a along the outer apply diameter B through the piston faces 40, 42 and the spring 34.

Thus, the actuator mechanism 30 applies the first engagement force to the adjacent plate 22a through the spring 34 and through the inner apply face 40 in the first engaged position along the inner apply diameter A through a first apply area 46 defined by the surface area at a distal end 48 of the spring 34. The actuator mechanism applies the second engagement force to the adjacent plate 22a through the spring 34 and through both of the inner and outer apply faces 40, 42 in the second engaged position along the outer apply diameter B through a second apply area 50, where the second apply area 50 is the surface area at the end of the actuator mechanism that includes the surface area at the end of the spring and the surface area defined by the outer apply face 42. Accordingly, the second apply area 50 is greater than the first apply area 46. However, it should be understood that the amount of force applied through the spring 34 and through the outer apply face 42 is not necessarily equal. Therefore, the distribution of force applied along the second apply area 50 in the second engaged position is not necessarily uniform.

The piston 32 and the spring 34 may be formed of any desirable materials for engaging the torque transmitting device 16. For example, the spring 34 may be formed of steel, and the piston 32 may be formed of steel or a hard aluminum, such as A390, or the piston 32 may be formed of a softer aluminum, such as A380, with a steel sleeve disposed between the piston 32 and the spring 34.

The description provided herein is merely exemplary in nature and variations that do not depart from the gist thereof are intended to be within the spirit and scope of the present disclosure. Such variations are not to be regarded as a departure from the spirit and scope of the present disclosure.

What is claimed is:

1. A mechanism for applying a force to engage a torque transmitting device, the mechanism comprising:
a piston having an inner apply face and an outer apply face, the inner apply face being offset from the outer apply face along an apply axis of the piston; and
a spring disposed adjacent to one of the inner apply face and the outer apply face, the spring being configured to contact an adjacent plate of the torque transmitting device, the mechanism being movable between a first engaged position, a second engaged position, and a disengaged position, the mechanism being configured to apply force to the adjacent plate through the spring and through one of the inner and outer apply faces in the first engaged position, the mechanism being configured to apply force to the adjacent plate through the spring and through both of the inner and outer apply faces in the second engaged position.

2. The mechanism of claim 1, the inner and outer apply faces being free from direct contact with the adjacent plate in the first engaged position, and one of the inner and outer apply faces being configured to directly contact the adjacent plate in the second engaged position.

3. The mechanism of claim 2, the mechanism being configured to apply a first engagement force to the adjacent plate through the spring in the first engaged position, and the mechanism being configured to apply a second engagement force to the adjacent plate through the spring and through the inner apply face and the outer apply face in the second engaged position, the second engagement force being greater than the first engagement force.

4. The mechanism of claim 2, the mechanism being configured to apply a first engagement force to the adjacent plate through the spring in the first engaged position through a first apply area, and the mechanism being configured to apply a second engagement force to the adjacent plate through the spring and through the inner apply face and the outer apply face in the second engaged position through a second apply area, the second apply area being greater than the first apply area.

5. The mechanism of claim 2, the spring being disposed adjacent to the inner apply face, and the outer apply face being configured to contact the adjacent plate in the second engaged position.

6. The mechanism of claim 2, the spring being a wave spring having multiple turns.

7. The mechanism of claim 6, the spring having a K factor in the range of 1.3 to 4.0 million Newtons per meter.

8. A torque transmitting device comprising:
a plurality of interleaved clutch plates configured to selectively couple a first member to a second member; and
an actuator mechanism disposed on one side of the plurality of interleaved clutch plates, the actuator mechanism configured to compress the plurality of clutch plates together to couple the first and second members, the actuator mechanism including:
a piston having an inner apply face and an outer apply face, the inner apply face being offset from the outer apply face along an apply axis of the piston; and
a spring disposed adjacent to one of the inner apply face and the outer apply face, the spring being configured to contact an adjacent plate of the plurality of interleaved clutch plates, the actuator mechanism being movable between a first engaged position, a second engaged position, and a disengaged position, the actuator mechanism being configured to apply force to the adjacent plate through the spring and through one of the inner and outer apply faces in the first engaged position, the actuator mechanism being configured to apply force to the adjacent plate through the spring and through both of the inner and outer apply faces in the second engaged position.

9. The torque transmitting device of claim 8, the inner and outer apply faces being free from direct contact with the adjacent plate in the first engaged position, and one of the inner and outer apply faces being in direct contact with the adjacent plate in the second engaged position.

10. The torque transmitting device of claim 9, the actuator mechanism being configured to apply a first engagement force to the adjacent plate through the spring in the first engaged position, and the actuator mechanism being configured to apply a second engagement force to the adjacent plate through the spring and through the inner apply face and the outer apply face in the second engaged position, the second engagement force being greater than the first engagement force.

11. The torque transmitting device of claim 10, the actuator mechanism being configured to apply the first engagement force to the plurality of interleaved clutch plates through the spring in the first engaged position through a first apply area, and the actuator mechanism being configured to apply the second engagement force to the plurality of interleaved clutch plates through the spring and through the inner apply face and the outer apply face in the second engaged position through a second apply area, the second apply area being greater than the first apply area.

12. The torque transmitting device of claim 11, the spring being disposed adjacent to the inner apply face, and the outer apply face being configured to contact the adjacent plate in the second engaged position.

13. The torque transmitting device of claim 12, the spring being a wave spring having multiple turns.

14. The torque transmitting device of claim 13, the spring having a K factor in the range of 1.3 to 4.0 million Newtons per meter.

15. A mechanism for applying a force to engage a torque transmitting device, the mechanism comprising:
an annular piston having an annular outer surface and an annular inner surface, the piston having an inner apply face and an outer apply face disposed between the inner annular surface and the outer annular surface, the outer apply face being disposed radially outward of the inner apply face, the inner apply face being axially offset from and disposed axially proximal of the outer apply face along an apply axis of the piston; and
a spring disposed adjacent to the inner apply face and radially inward of the annular outer surface of the piston to define a gap between the spring and the annular outer surface of the piston, the spring being configured to contact an adjacent plate of the torque transmitting device, the mechanism being movable between a first engaged position, a second engaged position, and a disengaged position, the mechanism being configured to apply force to the adjacent plate through the spring and the inner apply face in the first engaged position, the mechanism being configured to apply force to the apply plate through the spring and through the inner and the outer apply faces in the second engaged position.

16. The mechanism of claim 15, the spring defining an inner apply diameter along a mean diameter of the spring, and the inner apply face and the outer apply face together defining an outer apply diameter defined centrally between the annular inner surface and the annular outer surface of the piston, the mechanism being configured to apply force to the adjacent plate along the inner apply diameter in the first engaged position, and the mechanism being configured to apply force to the adjacent plate along the outer apply diameter in the second engaged position.

17. The mechanism of claim 16, the outer apply face being free from direct contact with the adjacent plate in the first engaged position, and the outer apply face being configured to directly contact the adjacent plate in the second engaged position.

18. The mechanism of claim 17, the mechanism being configured to apply a first engagement force to the adjacent plate through the spring in the first engaged position, and the mechanism being configured to apply a second engagement force to the adjacent plate through the spring and through the inner and the outer apply faces in the second engaged position, the second engagement force being greater than the first engagement force.

19. The mechanism of claim 18, the mechanism being configured to apply the first engagement force to the adjacent plate through the spring in the first engaged position through a first apply area, and the mechanism being configured to apply the second engagement force to the adjacent plate through the spring and through the inner and the outer apply faces in the second engaged position through a second apply area, the second apply area being greater than the first apply area.

20. The mechanism of claim 19, the spring being a wave spring having multiple turns, and the spring having a K factor in the range of 1.3 to 4.0 million Newtons per meter.
